(19) United States
(12) Patent Application Publication
(10) Pub. No.: US 2024/0037759 A1
(43) Pub. Date: Feb. 1, 2024

(54) TARGET TRACKING METHOD, DEVICE, MOVABLE PLATFORM AND COMPUTER-READABLE STORAGE MEDIUM

(71) Applicant: SZ DJI TECHNOLOGY CO., LTD., Shenzhen (CN)

(72) Inventor: Xuyang FENG, Shenzhen (CN)

(73) Assignee: SZ DJI TECHNOLOGY CO., LTD., Shenzhen (CN)

(21) Appl. No.: 18/377,812

(22) Filed: Oct. 8, 2023

Related U.S. Application Data
(63) Continuation of application No. PCT/CN2021/086258, filed on Apr. 9, 2021.

(51) Int. Cl. G06T 7/20; G06T 7/70; G06V 10/25; G06V 10/44; G06V 10/74

(52) U.S. Cl. CPC G06T 7/20; G06T 7/70; G06V 10/25; G06V 10/44; G06V 10/761; G06V 2201/07; G06T 2207/30252

(57) ABSTRACT

A target tracking method, device, a movable platform and a computer-readable storage medium are provided. The method includes: obtaining a first image containing a target to be tracked, and tracking the target to be tracked based on the first image; if the target to be tracked is lost, obtaining motion information of the target to be tracked when it is lost; based on the motion information, matching a target road area where the target to be tracked is located when it is lost in a vector map; and based on the motion information and the target road area, searching for the lost target to be tracked. The method improves the accuracy of target tracking.

### RELATED APPLICATIONS

This application is a continuation application of PCT application No. PCT/CN2021/086258, filed on Apr. 9, 2021, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of target tracking, and in particular, to a target tracking method, device, a movable platform and a computer-readable storage medium.

### BACKGROUND

At present, a movable platform can realize tracking and photographing images of targets to be tracked, such as tracking and photographing of people, cars, animals, etc. It mainly captures images including a target to be tracked, and achieves target tracking by identifying image features of the target to be tracked in the images. However, due to the occurrence of blocking and crossing, and the difficulties in distinguishing similar target objects with image features, the target to be tracked may be lost or changed, and the tracking photographing effect may be undesirable. Therefore, how to improve the accuracy of target tracking is an urgent problem that needs to be solved.

### SUMMARY

In light of the foregoing, exemplary embodiments of the present disclosure provide a target tracking method, device, a movable platform and a computer-readable storage medium, aiming to improve the accuracy of target tracking.

In one aspect, exemplary embodiments of the present disclosure provides a target tracking method, including: obtaining first information including a target to be tracked, and tracking the target to be tracked based on the first information; in response to a loss of tracking of the target to be tracked, obtaining motion information of the target to be tracked at a moment of the loss of tracking; matching, based on the motion information, a target area where the target to be tracked is located at the moment of the loss of tracking in a map; and searching for the target to be tracked that is lost from tracking based on the motion information and the target area.

Exemplary embodiments of the present disclosure provide a target tracking method, device, a movable platform and a computer-readable storage medium. The method includes: obtaining a first image containing a target to be tracked, tracking the target to be tracked based on the first image; if the target to be tracked is lost, obtaining motion information of the target to be tracked when it is lost, and based on the motion information, matching a target road area in which the lost target to be tracked is located when it is lost in a vector map, and finally, based on the motion information and the target road area, searching the lost target to be tracked. It may reduce the search range, facilitate the search for lost targets to be tracked, and greatly improve the accuracy of target tracking.

It should be understood that the above general description and the following detailed description are only exemplary and explanatory, and do not limit the present disclosure.

### BRIEF DESCRIPTION OF THE DRAWINGS

In order to more clearly illustrate the technical solutions of the embodiments of the present disclosure, the following will briefly introduce the drawings for the description of some exemplary embodiments. Apparently, the accompanying drawings in the following description are some exemplary embodiments of the present disclosure. For a person of ordinary skill in the art, other drawings may also be obtained based on these drawings without creative efforts.

FIG. 1 is a schematic diagram of an application scenario of a target tracking method according to some exemplary embodiments of the present disclosure;

FIG. 2 is a schematic flow chart of steps of a target tracking method according to some exemplary embodiments of the present disclosure;

FIG. 3 is a schematic flow chart of sub-steps of the target tracking method shown in FIG. 2;

FIG. 4 is a schematic diagram of a vector map area according to some exemplary embodiments of the present disclosure;

FIG. 5 is a schematic diagram of a vector map area according to some exemplary embodiments of the present disclosure;

FIG. 6 is a schematic diagram of a vector map area according to some exemplary embodiments of the present disclosure;

FIG. 7 is a schematic flow chart of sub-steps of the target tracking method shown in FIG. 2;

FIG. 8 is a schematic diagram of predicting the motion direction of a target to be tracked according to some exemplary embodiments of the present disclosure;

FIG. 9 is a schematic structural block diagram of a target tracking device according to some exemplary embodiments of the present disclosure; and

FIG. 10 is a schematic structural block diagram of a movable platform according to some exemplary embodiments of the present disclosure.

### DETAILED DESCRIPTION

The technical solutions in some exemplary embodiments of the present disclosure will be described below with reference to the accompanying drawings in the embodiments of the present disclosure. Obviously, the described embodiments are part of the embodiments of the present disclosure, but not all of the embodiments. Based on the exemplary embodiments in the present disclosure, all other embodiments obtained by a person of ordinary skill in the art without creative efforts fall within the scope of protection of the present disclosure.

The flow charts shown in the accompanying drawings are only examples and do not necessarily include all contents and operations/steps, nor are they necessarily performed in the order as described. For example, some operations/steps may also be separated, combined or partially merged. Therefore, the actual execution order may change based on actual conditions.

Some exemplary embodiments of the present application will be described in detail below with reference to the accompanying drawings. The following exemplary embodiments and features in the embodiments may be combined with each other without conflict.

At present, a movable platform can realize tracking and photographing images of targets to be tracked, such as tracking and photographing of people, cars, animals, etc. It mainly captures images including a target to be tracked, and achieves target tracking by identifying image features of the target to be tracked in the images. However, due to the occurrence of blocking and crossing, and the difficulties in distinguishing similar target objects with image features, the target to be tracked may be lost or changed, and the tracking photographing effect may be undesirable. Therefore, how to improve the accuracy of target tracking is an urgent problem that needs to be solved.

Exemplary embodiments of the present disclosure provide a target tracking method, device, a movable platform and a computer-readable storage medium. The method includes: obtaining a first image containing a target to be tracked, tracking the target to be tracked based on the first image; if the target to be tracked is lost, obtaining motion information of the target to be tracked when it is lost, and based on the motion information, matching a target road area in which the lost target to be tracked is located when it is lost in a vector map, and finally, based on the motion information and the target road area, searching the lost target to be tracked. It may reduce the search range, facilitate the search for lost targets to be tracked, and greatly improve the accuracy of target tracking.

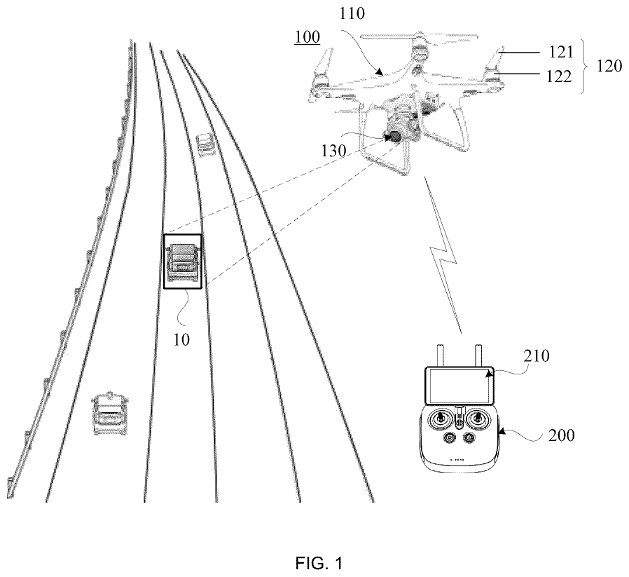

This target tracking method may be applied to movable platforms or remote control devices. The movable platforms herein may include unmanned aerial vehicles (UAVs), manned aircraft, unmanned vehicles, movable robots, etc. Please refer to FIG. 1, which is a schematic diagram of an application scenario of a target tracking method according to some exemplary embodiments of the present disclosure. As shown in FIG. 1, the scenario may include a UAV 100 and a remote control device 200. The remote control device 200 communicates with the UAV 100. The remote control device 200 is used to control the UAV 100, and the UAV is used to track a target 10 to be tracked, and send images captured by the UAV 100 to the remote control device 200 for display. The target to be tracked 10 may include vehicles, pedestrians, animals, etc., where the target to be tracked is movable.

In some exemplary embodiments, the UAV 100 may include a body 110, a power system 120, a photographing device 130 and a control system (not shown in FIG. 1). The power system 120 and the photographing device 130 may be installed on the body 110, and the control system may be located inside the body 110. The power system 120 is used to provide power for the UAV 100. The photographing device 130 may be coupled and mounted on a gimbal of the UAV 100, or may be integrally installed on the body 110 of the UAV 100 for collecting images. The photographing device 130 may specifically include a camera, that is, a monocular photographing solution; or it may include two cameras, a binocular photographing solution. Of course, the number of photographing devices 130 may be one or more. When there are multiple photographing devices 130, they may be distributed in multiple positions of the body 110. The multiple photographing devices 130 may work independently or in conjunction to achieve multi-angle photographing of the target to be tracked and obtain more image features.

The power system 120 may include one or more propellers 121, one or more motors 122 corresponding to the one or more propellers, and one or more electronic governors. The motor 122 may be connected between the electronic governor and the propeller 121, and the motor 122 and the propeller 121 are arranged on the body 110 of the UAV 100. The electronic governor is used to receive a driving signal generated by the control device and provide driving current to the motor 122 according to the driving signal to control the rotation speed of the motor 122.

The motor 122 may be used to drive the propeller 121 to rotate, thereby providing power for the UAV 100 to fly. This power enables the UAV 100 to achieve movement with one or more degrees of freedom. In some exemplary embodiments, the UAV 100 may rotate about one or more axes of rotation. For example, the above-mentioned rotation axis may include a roll axis, a yaw axis, and a pitch axis. It should be understood that the motor 122 may be a DC motor or an AC motor. In addition, the motor 122 may be a brushless motor or a brushed motor.

The control system may include a controller(s) and a sensing system(s). The sensing system may be used to measure the attitude information and motion information of the movable platform, such as three-dimensional position, three-dimensional angle, three-dimensional velocity, three-dimensional acceleration and three-dimensional angular velocity, etc. The attitude information is the position information and attitude information of the movable platform 100 in space. The sensing system may include, for example, at least one of a gyroscope, an ultrasonic sensor, an electronic compass, an inertial measurement unit (IMU), a vision sensor, a global navigation satellite system, a barometer, and other sensors. For example, the global navigation satellite system may be the Global Positioning System (GPS). The controller is used to control the movement of the movable platform 100. For example, the movement of the movable platform 100 may be controlled based on position information and/or attitude information measured by the sensing system. It should be understood that the controller may automatically control the movable platform 100 according to pre-programmed instructions.

The remote control device 200 is in communication with the display device 210. The display device 210 is used to display images collected by the photographing device 130 sent by the UAV 100. It should be noted that the display device 210 may include a display screen provided on the remote control device 200 or a display independent of the remote control device 200. The display independent of the remote control device 200 may include a mobile phone, a tablet computer, a personal computer, etc., or may also be other electronic devices with a display screen. The display screen may include an LED display screen, an OLED display screen, a LCD display screen, etc.

In some exemplary embodiments, the UAV 100 may also include a target tracking device (not shown in FIG. 1). The target tracking device obtains a first image containing a target to be tracked 10 collected by the photographing device 130, and tracks the target to be tracked 10 based on the first image; if the target 10 to be tracked is lost, it obtains motion information of the target to be tracked 10 when the target is lost; then according to the motion information, a target road area in which the target to be tracked 10 is located when it is lost is matched on a vector map (the vector map herein is merely an example, and any suitable map may be used in the present disclosure); and based on the motion information and the target road area, the lost target to be tracked is further searched.

In some exemplary embodiments, the remote control device 200 may further include a target tracking device. The target tracking device obtains a first image sent by the UAV including the tracking target 10, and controls the UAV 100 to track a target to be tracked 10 based on the first image; if the target 10 to be tracked is lost, it obtains motion information of the target to be tracked 10 when the target is lost; then according to the motion information, a target road area in which the target to be tracked 10 is located when it is lost is matched on a vector map; and based on the motion information and the target road area, the lost target to be tracked is further searched.

The UAV 200 may be, for example, a four-rotor UAV, a six-rotor UAV, or an eight-rotor UAV. Of course, it may also be a fixed-wing UAV, or a combination of rotor-type and fixed-wing UAV, which is not limited herein. The remote control device 200 may include, but is not limited to, a smart phone/mobile phone, a tablet computer, a personal digital assistant (PDA), a desktop computer, a media player, a video game station/system, a virtual reality system, an augmented reality system, a wearable device (e.g., a watch, glasses, a glove, a headwear (e.g., a hat, a helmet, a virtual reality headset, an augmented reality headset, a head mounted device (HMD), a headband), a pendant, an armband, a leg ring, shoes, a vest), a gesture recognition device, a microphone, an electronic device capable of providing or rendering image data, or any other type of device. The remote control device 200 may be a handheld terminal, and the remote control device 200 may be portable. The remote control device 200 may be carried by a human user. In some cases, the remote control device 200 may be located remotely from a human user, and the user may control the remote control device 200 using wireless and/or wired communications.

Next, a target tracking method provided by some exemplary embodiments of the present disclosure will be described in detail with reference to the application scenario in FIG. 1. It should be noted that the scenario in FIG. 1 is only used to explain the target tracking method provided by some exemplary embodiments of the present disclosure, but does not constitute a limitation on the application scenarios of the target tracking method provided herein.

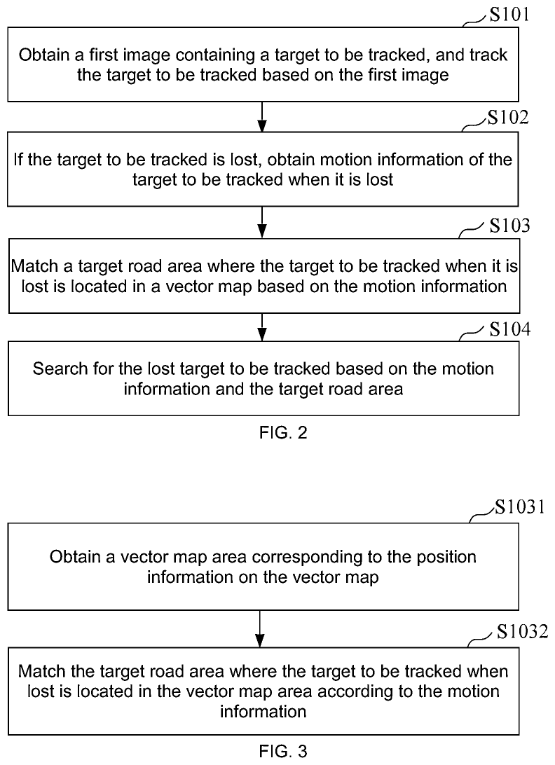

Please refer to FIG. 2, which is a schematic flow chart of steps of a target tracking method according to some exemplary embodiments of the present disclosure.

As shown in FIG. 2, the target tracking method may include steps S101 to S104.

Step S101: Obtain a first image containing a target to be tracked, and track the target to be tracked based on the first image.

Exemplarily, based on the first image and a target tracking algorithm, the position information of the target to be tracked at the next moment may be predicted, and the position of the movable platform and/or the photographing parameters of the photographing device on the movable platform may be adjusted based on the position information, so as to make the movable platform track the target to be tracked, so that the target to be tracked is always located in a center of an image captured by the photographing device. The movable platform may be stationary relative to the target to be tracked, or a distance between the movable platform and the target to be tracked may always be a fixed distance. The target tracking algorithm herein may include any one of the mean shift algorithm, the Kalman filter algorithm, the particle filter algorithm, and the moving target modeling algorithm. In some exemplary embodiments, other target tracking algorithms may also be used, which are not specifically limited herein.

The target to be tracked may include vehicles, pedestrians and animals, and the target to be tracked may be selected by a user via a human-computer interaction interface, or may be determined by identifying a specific target and/or salient target in the image. This is not limited herein. Categories for specific targets are included in a preset category library. Categories in the preset category library include categories of objects that may be recognized by target detection algorithms, such as pedestrians, vehicles, and ships. A salient target may be determined based on the saliency of a target object in the collected image(s). For example, when the saliency of a target object in the collected image(s) is greater than or equal to a preset saliency, the target object may be determined to be a salient target; when the saliency of a target object in the collected image(s) is less than the preset saliency, it may be determined that the target object is not a salient target. In some exemplary embodiments, the category of a salient target may be different from the category of a specific target.

In some exemplary embodiments, the saliency of a target object in the collected image may be determined based on duration the target object stays at a preset position in the image, and/or it may be determined based on a saliency value an image area where the target object is located in the collected image against an adjacent image area(s). It can be understood that the longer the duration when the target object stays at the preset position in the image, the higher the saliency of the target object in the collected image; the shorter the duration when the target object stays at the preset position in the image, the lower the saliency of the target object in the collected image. The greater the saliency (saliency value) of the image area where the target object is located in the collected image against the adjacent image area, the higher the saliency of the target object in the collected image; the smaller the saliency (saliency value) of the image area where the target object is located in the collected image against the adjacent image area, the lower the salience of the target object in the collected image.

In some exemplary embodiments, a salient target includes a target object located at a preset position in the image, and the target object stays at the preset position longer than a preset stay time; and/or, the salient target is located in a foreground in the image; and/or, the saliency value of the salient target of the image area in the image and the adjacent image area of the image area is greater than or equal to a preset saliency value, where the saliency value of the image area where the salient target is located against the adjacent image area may be determined based on a color difference and/or contrast between the image area where the salient target is located and the adjacent image area. The greater the color difference, the greater the saliency value; the smaller the color difference, the smaller the saliency value. The greater the contrast, the greater the saliency value; the smaller the contrast, the smaller the saliency value. The preset position, preset stay time and preset saliency value may be set based on the actual situations or set by a user. For example, the preset position may be the center of the image, the preset stay time may be 10 seconds, and the preset saliency value may be 50.

Step S102: If the target to be tracked is lost, obtain motion information of the target to be tracked when it is lost.

The motion information includes the position information and velocity information of the target to be tracked when it is lost, and the velocity information includes the motion speed and motion direction of the target to be tracked when it is lost.

In some exemplary embodiments, the relative position information of the target to be tracked relative to the movable platform and the position information of the movable platform when it is lost may be obtained; and then based on the relative position information and the position information of the movable platform, the position information of the target to be tracked when lost may be determined. The relative position information may be determined based on a visual device or a time of flight (TOF) sensor on the movable platform. The relative position information includes the relative distance and relative angle of the target to be tracked relative to the movable platform when it is lost. The visual device may be a monocular visual device or a multi-ocular visual device. The position information of the movable platform may be collected based on a positioning module in the movable platform. The positioning module may be a global positioning system (GPS) positioning module or a real-time kinematic (RTK) positioning module.

In some exemplary embodiments, a first image and a second image collected by a binocular vision device on the movable platform at the moment before the target to be tracked is lost may be obtained. Both the first image and the second image include the target to be tracked. Feature point matching pairs corresponding to multiple spatial points on the target to be tracked may be extracted from the first image and the second image, where the feature point matching pair includes a first feature point located in the first image and a second feature point located in the second image; based on multiple feature point matching pairs, the relative distance of the target to be tracked relative to the movable platform when it is lost may be determined. The binocular vision device may include a first photographing device and a second photographing device, where the first image is captured by the first photographing device, and the second image is captured by the second photographing device.

Exemplarily, first feature points corresponding to multiple spatial points on the target to be tracked may be extracted from the first image based on a preset feature point extraction algorithm; second feature points matching the first feature points may be determined from the second image based on a preset feature point tracking algorithm, and feature point matching pairs corresponding to the multiple spatial points on the target to be tracked may be obtained. Alternatively, second feature points corresponding to multiple spatial points on the target to be tracked may be extracted from the second image based on a preset feature point extraction algorithm; and first feature points matching the second feature points may be determined from the first image based on a preset feature point tracking algorithm, and then feature point matching pairs corresponding to the multiple spatial points on the target to be tracked may be obtained. Herein, the preset feature point extraction algorithm may include at least one of the following: Harris Corner Detection, scale-invariant feature transform (SIFT) algorithm, Speeded-Up Robust Features (SURF) algorithm, Features From Accelerated Segment Test (FAST) feature point detection algorithm; the preset feature point tracking algorithm may include, but is not limited to, Kanade-Lucas-Tomasi (KLT) feature tracker algorithm.

Exemplarily, based on the pixels of two feature points in each feature point matching pair, the corresponding pixel difference of each feature point matching pair may be determined; a preset focal length and a preset binocular distance of the binocular vision device may be obtained; and then based on the preset focal length, the preset binocular distance and the corresponding pixel difference of each feature point matching pair, the relative distance of the target to be tracked relative to the movable platform when the target is lost may be determined. The preset focal length may be determined by calibrating the focal length of the binocular vision device. The preset binocular distance may be determined based on the installation positions of the first photographing device and the second photographing device in the binocular vision device.

In some exemplary embodiments, multiple frames of first images may be obtained; and then the velocity information of the target to be tracked when it is lost may be determined based on the multiple frames of first images. The difference between the photographing moments of the multiple frames of first images and the moment when the target is lost may be less than or equal to a preset difference. The preset difference value may be set based on actual conditions, and this is not specifically limited herein. For example, if the preset difference value is 1 second and the losing moment is t, then multiple frames of first images whose photographing moments are between t−1 (one second before the losing moment) and the losing moment t may be obtained.

Exemplarily, the multiple frames of first images may be input into a preset target detection model to obtain target detection information of the target to be tracked at different moments. According to the target detection information of the target to be tracked at different moments, the position information of the target to be tracked at different moments in the world coordinate system may be determined; and then based on the position information of the target to be tracked in the world coordinate system at different moments and the image photographing interval, the velocity information of the target to be tracked when it is lost may be determined.

The target detection information includes the dimensional information of the target to be tracked, the angle information of the target to be tracked relative to the movable platform, and the position information of the target to be tracked in a camera coordinate system. The angle information of the target to be tracked relative to the movable platform includes the yaw angle, pitch angle and roll angle of the target to be tracked relative to the movable platform. The dimensional information includes the length information, width information and/or height information of the target to be tracked in the world coordinate system.

In some exemplary embodiments, the present target detection model may be a pre-trained neural network model, and its training method may be as follows: obtain training sample data, where the training sample data includes multiple first images and target detection information of the target to be tracked in each first image; perform iterative training with a neural network model based on the training sample data until the neural network model converges after the iterative training, so as to obtain a preset target detection model. The neural network model includes any one of a convolutional neural network model CNN, a deep convolutional neural network model RCNN, a fast deep convolutional neural network model Fast RCNN, and a faster deep convolutional neural network model Faster RCNN.

Step S103: Match a target road area where the target to be tracked when it is lost is located in a vector map based on the motion information.

The vector map may include map information of the whole country or the map information of the city where the movable platform is registered. The vector map may be stored in the movable platform, in the remote control device, or in a cloud server. This is not specifically limited herein.

In some exemplary embodiments, the position information of the movable platform may be obtained; and then a vector map may be obtained based on the position information of the movable platform, that is, a vector map containing the area where the position information of the movable platform is located. For example, the city where the movable platform is currently located may be determined based on the position information of the movable platform, and the map of the city may be determined as the vector map. The vector map may be obtained before tracking the target to be tracked, or may be obtained when the target to be tracked is lost, or may be obtained during the process of tracking the target to be tracked. This is not limited herein. Since the target to be tracked is usually not far away from the movable platform, a more accurate vector map may be obtained based on the position information of the movable platform, which facilitates subsequent matching of the road area to which the target to be tracked is located on the vector map.

In some exemplary embodiments, as shown in FIG. 3, step S103 may include: sub-steps S1031 to S1032.

Sub-step S1031: Obtain a vector map area corresponding to the position information on the vector map.

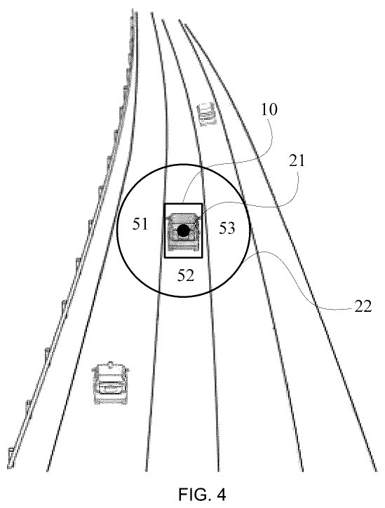

Exemplarily, a position point corresponding to the position information of the target to be tracked on the vector map may be used as a center point, and an area formed based on a preset area may be determined as a vector map area. The outline shape of the vector map area may include a circle or a rectangle, or may also include a pentagon, an ellipse, a sector, etc., which is not limited herein. The preset distance may be set based on actual conditions, and this is also not specifically limited herein. In some exemplary embodiments, the preset area may be 10 or 4π square meters. For example, as shown in FIG. 4, the position point corresponding to the position information of the target to be tracked on the vector map is taken as the center point 21, and the circular area 22 formed with a radius of 2 meters is determined as the vector map area. The vector map area includes a road area 51, a road area 52 and a road area 53.

Sub-step S1032: Match the target road area where the target to be tracked when lost is located in the vector map area according to the motion information.

The vector map area corresponding to the position information of the target to be tracked when it is lost may be obtained from the vector map, and then based on the motion information of the target to be tracked when it is lost, the target road area where the target to be tracked when it is lost is located may be matched in the vector map area. It may reduce the losing range of the lost target to be tracked, thereby reducing the amount of calculation.

In some exemplary embodiments, determine distance errors between the target to be tracked and each road area in the vector map area based on the position information of the target to be tracked when it is lost; determine the matching priority of each road area based on the distance error between the target to be tracked and each road area in the vector map area; according to the matching priority, sequentially select a road area and determine an angle error between a driving direction corresponding to the selected road area and a motion direction of the target to be tracked; if the angle error is less than or equal to a first threshold, the currently selected road area is determined as the target road area. Herein, the matching priority is negatively correlated with the distance error. That is, the smaller the distance error, the higher the matching priority, and the larger the distance error, the lower the matching priority. The first threshold may be set based on actual conditions, and this is not specifically limited herein.

Exemplarily, the distance error between the target to be tracked and the road area may be determined as follows: divide the road area in the vector map area into multiple road sub-areas, and determine a starting point position information of each road sub-area, according to the starting point position information of each road sub-area and the position information of the target to be tracked, the distance between the target to be tracked and each road sub-area is determined, and then the smallest distance among the distances between the target to be tracked and each road sub-area may be determined as the distance error between the target to be tracked and the road area.

Exemplarily, determine the total length of the road area in the vector map area, and determine the number of road sub-areas based on the total length, then, taking one end point of the road area as the starting position point, the road area in the vector map area may be divided into multiple road sub-areas according to the number of divisions and the total length. For example, obtain the latitude and longitude information of the starting point position of the road area from the vector map area; determine the latitude and longitude information of the starting point position as the starting position information of the first road sub-area; according to the starting point position information of the first road sub-area and the length of the first road sub-area, determine the starting point position information of the next road sub-area. In a similar manner, the starting point position information of each road sub-area may be determined. Herein, the number of divisions may be determined based on a mapping relationship between the total length and the number of divisions, and the total length of the road area. There is a positive correlation between the number of road sub-areas divided and the total length of the road area. That is, the longer the total length of the road area, the greater the number of divided road sub-areas; the shorter the total length of the road area, the smaller the number of divided road sub-areas.

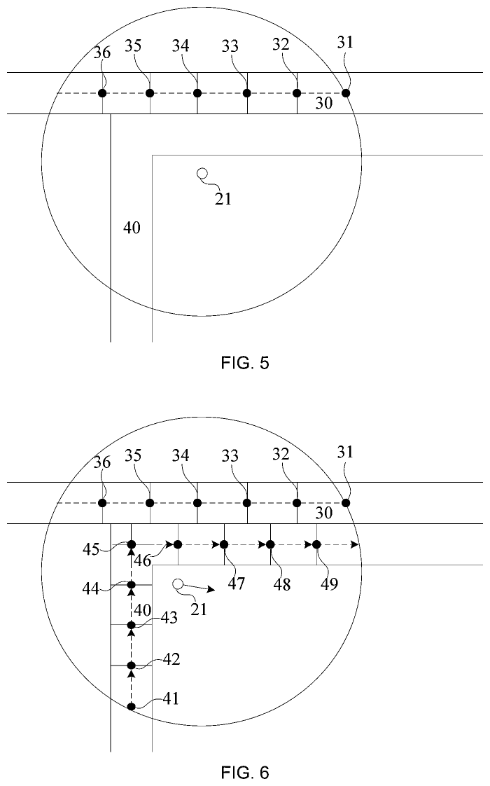

Exemplarily, as shown in FIG. 5, the vector map area may include road area 30 and road area 40, and the road area 30 may be divided into 6 road sub-areas, which are a first road sub-area between the position point 31 and the position point 32, a second road sub-area between the position point 32 and the position point 33, a third road sub-area between the position point 33 the position point 34, a fourth road sub-area between position point 34 and the position point 35, a fifth road sub-area between the position point 35 and the position point 36, and a sixth road sub-area between the position point 36 and one end point of road area 30. The starting point position information of the first road sub-area is the longitude and latitude information corresponding to the position point 31. The starting point position information of the second road sub-area is the latitude and longitude information corresponding to the position point 32. The starting point position information of the third road sub-area is the longitude and latitude information corresponding to the position point 33. The starting point position information of the fourth road sub-area is the longitude and latitude information corresponding to the position point 34. The starting point position information of the fifth road sub-area is the longitude and latitude information corresponding to the position point 35. The starting point position information of the sixth road sub-area is the longitude and latitude information corresponding to the position point 36. The position point of the target to be tracked in the vector map area is the center point 21. It may be seen through calculation that the distance between the center point 21 and the position point 34 is the smallest. Therefore, the distance between the center point 21 and the position point 34 may be determined as the distance error between the target to be tracked and the road area 30.

Exemplarily, the angle error between the driving direction corresponding to the selected road area and the motion direction of the target to be tracked may be determined as follows: divide the selected road area into multiple road sub-areas, and determine the driving direction corresponding to each road sub-area; determine an angle between the motion direction of the target to be tracked and the driving direction corresponding to each road sub-area, and then the smallest angle among the angles between the motion direction of the target to be tracked and the driving directions corresponding to each road sub-area may be determined as the angle error between the driving direction corresponding to the selected road area and the motion direction of the target to be tracked.

For example, as shown in FIG. 6, the position point of the target to be tracked in the vector map area is the center point 21, and the vector map area includes a road area 30 and a road area 40. The road area 40 may be divided into 9 road sub-areas, including a road sub-area 1 between the position point 41 and the position point 42, a road sub-area 2 between the position point 42 and the position point 43, a road sub-area 3 between the position point 43 and the position point 44, a road sub-area 4 between the position point 44 and the position point 45, a road sub-area 5 between the position point 45 and the position point 46, a road sub-area 6 between the position point 46 and the position point 47, a road sub-area 7 between the position point 47 and the position point 48, a road sub-area 8 between the position point 48 and the position point 49, and a road sub-area 9 between the position point 49 and one end point of the road area 40. In addition, the driving direction of road sub-area 1, road sub-area 2, road sub-area 3 and road sub-area 4 is a first direction, and the driving direction of road sub-area 5, road sub-area 6, road sub-area 7, road sub-area 8 and road sub-area 9 is a second direction. The first direction and the second direction are different. The motion direction of the target to be tracked is a third direction. It may be found through calculation that the angle between the motion direction of the target to be tracked and the second direction is the smallest, then the angle between the motion direction of the target to be tracked and the second direction may be determined as the angle error.

In some exemplary embodiments, determine an angle error between the motion direction of the target to be tracked when it is lost and the corresponding driving direction of each road area in the vector map area; determine a matching priority of each road area based on the angle error between the motion direction of the target to be tracked when it is lost and the corresponding driving direction of each road area in the vector map area; based on the matching priority, a road area may be sequentially selected, and based on the position information of the target to be tracked, a distance error between the target to be tracked and the selected road area is determined; if the distance error is less than or equal to a second threshold, the currently selected road area may be determined as the target road area. Herein, the matching priority is negatively correlated with the angle error, that is, the smaller the angle error, the higher the matching priority; the larger the angle error, the lower the matching priority. The second threshold may be set based on actual conditions, and is not limited herein.

In some exemplary embodiments, determine a distance error between the target to be tracked and each road area in the vector map area based on the position information of the target to be tracked when it is lost; determine an angle error between the motion direction of the target to be tracked when it is lost and the corresponding driving direction of each road area; based on the distance error between the target to be tracked and each road area in the vector map area and the angle error between the motion direction of the target to be tracked when it is lost and the corresponding driving direction of each road area, a target road area may be determined within the vector map area. By comprehensively considering the position information and motion direction of the target to be tracked when it is lost, the target road area of the target to be tracked in the vector map area may be quickly matched/identified.

Exemplarily, based on the distance error between the target to be tracked and each road area in the vector map area and the angle error between the motion direction of the target to be tracked when it is lost and the corresponding driving direction of each road area, determine the degree of match between the target to be tracked and each road area; the road area with the highest matching degree may be determined as the target road area. For example, as shown in FIG. 4, the vector map includes a road area 51, a road area 52 and a road area 53. The matching degrees between the target to be tracked 10 and the road area 51, road area 52 and road area 53 are 60% and 98% and 70%, respectively. Since the matching degree between the target to be tracked 10 and the road area 52 is the highest, the road area 52 is determined as the target road area.

Exemplarily, based on the distance error and the angle error, the way to determine the matching degree between the target to be tracked and the road area may be as follows: obtain a first matching degree corresponding to the distance error and a second matching degree corresponding to the angle error; perform a weighted sum on the first matching degree and the second matching degree to obtain a matching degree between the target to be tracked and the road area. By comprehensively considering the distance error and angle error to determine the matching degree between the target to be tracked and the road area, the accuracy of the matching degree may be improved.

For example, perform a multiplication operation on the first matching degree and a first weighting coefficient to obtain a first multiplication operation result, and perform a multiplication operation on the second matching degree and a second weighting coefficient to obtain a second multiplication operation result, and then the first multiplication result and the second multiplication result are added together to obtain the matching degree between the target to be tracked and the road area. The first weighting coefficient and the second weighting coefficient may be set based on actual conditions, which is not limited herein.

Step S104: Search for the lost target to be tracked based on the motion information and the target road area.

The target road area corresponds to the driving direction. At different positions in the target road area, the corresponding driving directions may be different or the same. For example, in a scenario where the target road area is a straight line, the driving direction corresponding to the target road area may be straight forward or straight backward. In a scenario where the target road area is a curve, the driving direction corresponding to the target road area may be a tangent direction of the curve.

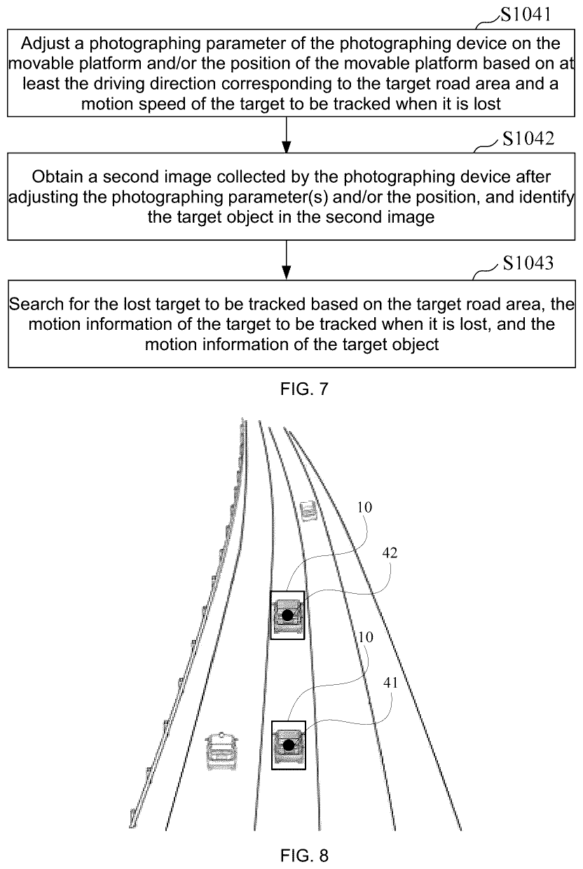

In some exemplary embodiments, as shown in FIG. 7, step S104 may include: sub-steps S1041 to S1043.

Sub-step S1041: Adjust a photographing parameter of the photographing device on the movable platform and/or the position of the movable platform based on at least the driving direction corresponding to the target road area and a motion speed of the target to be tracked when it is lost.

It is understandable that the photographing parameter(s) of the photographing device may be adjusted alone, or the position of the movable platform may be adjusted alone, or the photographing parameter(s) of the photographing device and the position of the movable platform may be adjusted at the same time, which is not specifically limited herein.

In some exemplary embodiments, based on the driving direction corresponding to the target road area and the motion speed of the target to be tracked when it is lost, predict a target motion direction of the target to be tracked; based on the predicted target motion direction, adjust the photographing parameter(s) of the photographing device on the movable platform. The photographing parameter(s) may include a photographing direction and a focal length, and may also include other parameters, such as the attitude during photographing. Based on the driving direction corresponding to the target road area and the motion speed, the motion direction of the target to be tracked in the next period of time may be predicted. The photographing direction of the photographing device on the movable platform may be accurately adjusted based on the predicted motion direction, so that the photographing device may face toward the most likely direction of the target to be tracked, making it easier to search for the lost target to be tracked. By adjusting the focal length of the photographing device, the size of the object in the image captured by the photographing device may be changed, making it easier to subsequently search for the lost target to be tracked with clear images. For example, the focal length may be reduced to obtain clearer image features for searching for the lost target to be tracked. Alternatively, the focal length may be increased to obtain more candidate target objects for searching for the lost target to be tracked. The specific method may be selected according to the specific situations.

Exemplarily, determine a target photographing direction of the photographing device based on the predicted target motion direction, and obtain a current photographing direction of the photographing device on the movable platform; determine a rotation angle of a gimbal equipped with the photographing device based on the current photographing direction and the target photographing direction, and control the gimbal to rotate based on the rotation angle, so that the photographing direction of the photographing device may be changed to the target photographing direction, or determine a target attitude of the movable platform based on the current photographing direction and the target photographing direction, and adjust the attitude of the movable platform to the target attitude, so that the photographing direction of the photographing device may be changed to the target photographing direction.

Exemplarily, multiply the motion speed of the target to be tracked when it is lost and a preset interval time to obtain a moving distance of the target to be tracked in the target road area; and take a position point in the target road area when the target to be tracked is lost as a starting position point, mark a position point in the target road area where the target to be tracked has moved the moving distance along the driving direction corresponding to the target road area; obtain the driving direction of the marked position point in the target road area, and determine the driving direction at the marked position point in the target road area as a target motion direction of the target to be tracked. The preset interval time may be set based on actual conditions, which is not specifically limited herein.

For example, as shown in FIG. 8, the position point of the target 10 to be tracked at the losing moment t is a first position point 41, the motion speed of the target to be tracked 10 is 60 km/h (approximately 16.7 m/s), the preset interval time is 1 s; then the target to be tracked starts from the exposure moment t and the moving distance after 1 second is 16.7 meters. At this time, the target to be tracked 10 is located at a second position point 42. The driving direction at the second position point 42 in the target road area is forward, and thus the target motion direction of the target to be tracked 10 is also forward.

In some exemplary embodiments, determine the moving distance of the movable platform based on the motion speed of the target to be tracked when it is lost and the losing duration after the target to be tracked is lost; adjust the position of the movable platform based on the moving distance and the driving direction corresponding to the target road area. Since the losing duration of the target to be tracked is constantly changing, the moving distance of the movable platform also changes accordingly. In this way, the position of the movable platform may also change synchronously, which may make the photographing device on the movable platform face toward the direction where the target to be tracked is most likely to be, thereby making it easier to search for the lost target to be tracked.

The moving distance of the movable platform gradually increases as the losing duration gradually increases. For example, the motion speed of the target to be tracked 10 when it is lost is 60 km/h (approximately 16.7 m/s); after being lost for 1 second, the moving distance of the movable platform is 16.7 m, after being lost for 2 seconds, the movable platform has moved 35.4 meters, and after being lost for 3 seconds, the movable platform has moved 50.1 meters.

Sub-step S1042: Obtain a second image collected by the photographing device after adjusting the photographing parameter(s) and/or the position, and identify the target object in the second image.

After adjusting the photographing parameter(s) of the photographing device on the movable platform and/or the position of the movable platform, obtain a second image collected by the photographing device, and then the second image is input into a target identification model to identify the target object in the second image, where the target identification model is a pre-trained neural network model.

Sub-step S1043: Search for the lost target to be tracked based on the target road area, the motion information of the target to be tracked when it is lost, and the motion information of the target object.

Based on the target road area, the motion information of the target to be tracked when it is lost, and the motion information of the target object, the lost target to be tracked may be searched quickly and accurately. If there is one target object, determine the distance between the target object and the target road area based on the position information of the target object, and determine the angle between the motion direction of the target object and the driving direction corresponding to the target road area. If the distance is less than or equal to a preset distance and the angle is less than or equal to a preset angle, it is determined that the target object is the lost target to be tracked. The preset distance and the preset angle may be set based on actual conditions, which is not specifically limited herein.

In some exemplary embodiments, if there are multiple target objects, determine a candidate target object(s) located in the target road area from the multiple target objects based on the motion information of the multiple target objects; if there are multiple candidate target objects, determine a deviation between the motion speed of the target to be tracked when it is lost and the motion speed of each candidate target object; and at least based on the deviation, a target to be tracked may be determined from the multiple candidate target objects, where the target object with the smallest deviation may be determined as the target to be tracked.

Exemplarily, determine the distances between each target object and the target road area based on the position information of the multiple target objects; the target object(s) whose distance is less than or equal to a preset distance may be determined as the candidate target object(s) located within the target road area. Based on the motion information of multiple target objects, match the road areas where the multiple target objects are located in the vector map; and then a target object whose road area is the same as the target road area may be determined as the candidate target object.

In some exemplary embodiments, extract image features of the target to be tracked from the first image; determine the target to be tracked from multiple candidate target objects based on the image features of the target to be tracked and the deviation between the motion speed of the target to be tracked when it is lost and the motion speed of each candidate target object. In this case, the way to determine the target to be tracked based on the deviations and the image features may be as follows: based on the image features of the target to be tracked, determine a candidate target object that matches the target to be tracked from the multiple candidate target objects; based on the deviations between the motion speed of the target to be tracked when it is lost and the motion speed of each candidate target object, the target to be tracked may be determined from the candidate target objects matching the target to be tracked, where the candidate target object matching the target to be tracked with the smallest deviation may be determined as the target to be tracked. Thus, by comprehensively considering the image features and motion speed of the target to be tracked, the lost target to be tracked may be accurately searched for.

For example, the candidate target objects include candidate target object 1, candidate target object 2, candidate target object 3, candidate target object 4, and candidate target object 5, and the candidate target objects matching the target to be tracked include candidate target object 1, candidate target object 3 and candidate target object 5. The deviations between the motion speed of the target to be tracked when it is lost and the corresponding motion speeds of candidate target object 1, candidate target object 3 and candidate target object 5 are 20, 50 and 5 respectively, then the candidate target object 5 with the smallest deviation may be determined as the target to be tracked.

In some exemplary embodiments, in the process of tracking the target to be tracked, the motion information of the target to be tracked may be corrected based on the target road area; and then track and photograph the target to be tracked based on the corrected motion information. The motion information of the target to be tracked may be corrected based on the target road area, and then the target to be tracked may be tracked based on the corrected motion information. This may improve the accuracy of target tracking.

Exemplarily, obtain the target position information of the target to be tracked in the target road area, and replace the position information of the target to be tracked with the target position information, and/or replace the motion direction of the target to be tracked with the driving direction corresponding to the target road area. If the matching degree between the target road area and the target to be tracked is greater than or equal to a preset matching degree, a correction coefficient may be determined based on the matching degree; based on the correction coefficient and the target position information of the target to be tracked in the target road area, the position information of the target to be tracked may be corrected, and/or the motion direction of the target to be tracked may be corrected based on the correction coefficient and the driving direction corresponding to the target road area.

The position information of the target to be tracked may be obtained as follows: obtain the relative position information of the target to be tracked relative to the movable platform and the position information of the movable platform; the position information of the target to be tracked may be determined based on the relative position information and the position information of the movable platform.

The correction coefficient is positively correlated with the degree of matching. That is, the higher the matching degree, the larger the correction coefficient, and the lower the matching degree, the smaller the correction coefficient. In some exemplary embodiments, if the matching degree between the target road area and the target to be tracked is less than a preset matching degree, the motion information of the target to be tracked may not be corrected. The preset matching degree may be set based on actual conditions, which is not specifically limited herein.

In some exemplary embodiments, obtain the first image containing the target to be tracked, and track the target to be tracked based on the first image; if the target to be tracked is not lost, real-time motion information of the target to be tracked is obtained, and then based on real-time motion information, the target road area where the target to be tracked is located may be matched in the vector map; based on the target road area, the real-time motion information of the target to be tracked is corrected; and then track and photograph the target to be tracked based on the corrected real-time motion information. The existing real-time motion information for determining the target to be tracked mainly estimates the position information of the target to be tracked at different times based on multiple frames of images including the first image of the target to be tracked, then use the position information at different times to estimate the real-time motion information of the target to be tracked. Since the estimated position information may be affected by image recognition, in some cases it may cause a large deviation in the estimated position information. As a result, the estimated real-time motion information may also have a large deviation. In the present disclosure, the motion information may be corrected by introducing road information in a vector map, which may effectively improve the accuracy of motion information, thereby improving the accuracy of target tracking.

In some exemplary embodiments, in at least one of the following cases: before tracking the target to be tracked, during tracking the target to be tracked, after the target to be tracked is lost, or when the target to be tracked is found, mark the corresponding information on the display device, such as the position of the movable platform, vector map area, target road area, position information when the target to be tracked is lost or before it is lost, the driving direction of the target to be tracked, etc. The specific mark form is not limited, such as size, color, shape, dynamic and static display, etc.

Exemplarily, show the vector map, and the vector map may include multiple road areas. Based on the real-time motion information of the target to be tracked, the target to be tracked may be marked in real time in the road area(s) of the vector map. The driving direction of each road area may also be marked on the vector map. When marking the target to be tracked, mark the vector map area and target road area containing the target to be tracked. By displaying the vector map and marking the target to be tracked in the road area of the vector map in real time, it is convenient for a user to better control the movable platform to track the target to be tracked.

Exemplarily, if the target to be tracked is lost, the losing position point may be marked on the vector map based on the position information of the target to be tracked at the losing moment. The losing position point may be marked in a different way than the target to be tracked. If the lost target to be tracked is found again, the previously marked losing position point may be deleted, and the target to be tracked may be re-marked in the road area of the vector map based on the real-time motion information of the target to be tracked. By marking the losing location point when the target to be tracked is lost, it is convenient for a user to know that the target to be tracked has been lost.

The target tracking method described above includes: obtaining a first image containing a target to be tracked, tracking the target to be tracked based on the first image; if the target to be tracked is lost, obtaining motion information of the target to be tracked when it is lost, and based on the motion information, matching a target road area in which the lost target to be tracked is located when it is lost in a vector map, and finally, based on the motion information and the target road area, searching the lost target to be tracked. It may reduce the search range, facilitate the search for lost targets to be tracked, and greatly improve the accuracy of target tracking.

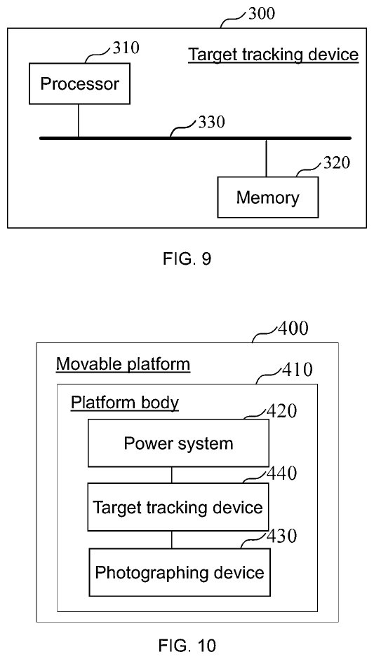

With reference to FIG. 9, FIG. 9 is a schematic structural block diagram of a target tracking device according to some exemplary embodiments of the present disclosure.

As shown in FIG. 9, a target tracking device 300 may include a processor 310 and a memory 320. The processor 310 and the memory 320 are connected via a bus 330, such as an I2C (Inter-integrated Circuit) bus.

Specifically, the processor 310 may be a micro-controller unit (MCU), a central processing unit (CPU) or a digital signal processor (DSP), etc.

Specifically, the memory 320 may be a Flash chip, a read-only memory (ROM) disk, an optical disk, a USB disk or a mobile hard disk, etc.

The processor 310 may be used to execute the computer program stored in the memory 320, and implement the following steps when executing the computer program:
Obtain a first image containing a target to be tracked, and tracking the target to be tracked based on the first image;
If the target to be tracked is lost, obtain motion information of the target to be tracked when it is lost, where the motion information includes the position information and velocity information of the target to be tracked when it is lost;
Based on the motion information, match a target road area where the target to be tracked when it is lost is located in a vector map;
Based on the motion information and the target road area, search for the lost target to be tracked.

In some exemplary embodiments, when obtaining the motion information of the target to be tracked when it is lost, the processor is used to:
Obtain relative position information of the target to be tracked relative to a movable platform when it is lost and position information of the movable platform;
Based on the relative position information and the position information of the movable platform, determine the position information of the target to be tracked when it is lost.

In some exemplary embodiments, when obtaining the motion information of the target to be tracked when it is lost, the processor is used to:
Obtain multiple frames of the first image;
Based on the multiple frames of the first image, determine velocity information of the target to be tracked when it is lost.

In some exemplary embodiments, when matching the target road area where the target to be tracked is located when it is lost in the vector map based on the motion information, the processor is used to:
Obtain a vector map area corresponding to the position information on the vector map;
Based on the motion information, match the target road area where the target to be tracked is located when it is lost in the vector map area.

In some exemplary embodiments, when obtaining the vector map area corresponding to the position information in the vector map, the processor is used to:

Use a position point corresponding to the position information in the vector map as a center point, and determine an area formed by a preset area as the vector map area.

In some exemplary embodiments, the outline shape of the vector map area includes a circle or a rectangle.

In some exemplary embodiments, when matching, based on the motion information, the target road area where the target to be tracked is located when it is lost in the vector map area, the processor is used to:
Determine distance errors between the target to be tracked and road areas in the vector map area based on the position information of the target to be tracked when it is lost;
Determine a matching priority of each road area based on the respective distance error;
Sequentially select a road area based on the matching priority, and determine an angle error between a driving direction corresponding to the selected road area and a motion direction of the target to be tracked;
If the angle error is less than or equal to a first threshold, determine the currently selected road area as the target road area.

In some exemplary embodiments, when matching, based on the motion information, the target road area where the target to be tracked is located when it is lost in the vector map area, the processor is used to:
Determine an angle error between the motion direction of the target to be tracked when it is lost and a corresponding driving direction of each road area in the vector map area;
Determine a matching priority of each road area based on the angle error;
Sequentially select a road area based on the matching priority, and determine a distance error between the target to be tracked and the selected road area based on the position information of the target to be tracked;
If the distance error is less than or equal to a second threshold, determine the currently selected road area as the target road area.

In some exemplary embodiments, when matching. based on the motion information, the target road area where the target to be tracked is located when it is lost in the vector map area, the processor is used to:
Determine a distance error between the target to be tracked and each road area in the vector map area based on the position information of the target to be tracked when it is lost;
Determine a angle error between the motion direction of the target to be tracked when it is lost and a corresponding driving direction of each of the road areas;
Determine the target road area in the vector map area based on the distance error and the angle error.

In some exemplary embodiments, when determining the target road area in the vector map area based on the distance error and the angle error, the processor is used to:
Determine a matching degree between the target to be tracked and each of the road areas based on the distance error and the angle error;
Determine a road area with the highest matching degree as the target road area.

In some exemplary embodiments, the processor is used to:
Obtain position information of the movable platform;
Obtain the vector map based on the position information of the movable platform.

In some exemplary embodiments, when searching for the lost target to be tracked based on the motion information and the target road area, the processor is used to:
Adjust a photographing parameter(s) of a photographing device on the movable platform and/or a position of the movable platform based on at least a driving direction corresponding to the target road area and a motion speed of the target to be tracked when it is lost;
Obtain a second image collected by the photographing device after adjusting the photographing parameter(s) and/or the position, and identify a target object in the second image;
Search for the lost target to be tracked based on the target road area, the motion information of the target to be tracked when it is lost, and the motion information of the target object.

In some exemplary embodiments, when adjusting the photographing parameter(s) of the photographing device on the movable platform based on the driving direction corresponding to the target road area and the motion speed of the target to be tracked when it is lost, the processor is used to:
Predict a target motion direction of the target to be tracked based on the driving direction corresponding to the target road area and the motion speed of the target to be tracked when it is lost;
Adjust the photographing parameter(s) of the photographing device on the movable platform based on a predicted target motion direction, where the photographing parameter(s) include a photographing direction and a focal length.

In some exemplary embodiments, when adjusting the position of the movable platform based on the driving direction corresponding to the target road area and the motion speed of the target to be tracked when it is lost, the processor is used to:
Determine a moving distance of the movable platform based on the the motion speed of the target to be tracked when it is lost and a duration since the target to be tracked is lost;
Adjust the position of the movable platform based on the moving distance and the driving direction corresponding to the target road area.

In some exemplary embodiments, when searching for the lost target to be tracked based on the target road area, the motion information of the target to be tracked when it is lost, and the motion information of the target object, the processor is used to:
Determine at least one candidate target object(s) located in the target road area from multiple target objects based on the motion information of the multiple target objects;
If there are multiple candidate target objects, determine a deviation between the motion speed of the target to be tracked when it is lost and the motion speed of each candidate target object;
Determine the target to be tracked from the multiple candidate target objects based on at least the deviation.

In some exemplary embodiments, when determine the candidate target object located in the target road area from the multiple target objects based on the motion information of the multiple target objects, the processor is used to:
Determine a distance between each of the target objects and the target road area based on the position information of the multiple target objects;
Determine a target object whose distance is less than or equal to a preset distance as the candidate target object located within the target road area.

In some exemplary embodiments, when determining the candidate target object located in the target road area from the multiple target objects based on the motion information of the multiple target objects, the processor is used to:
Based on the motion information of multiple target objects, match road areas where the multiple target objects are located in the vector map;
Determine a target object whose road area and the target road area are the same as the candidate target object.

In some exemplary embodiments, when determining the target to be tracked from multiple candidate target objects based on the deviation, the processor is used to:
Extract image features of the target to be tracked from the first image;
Determine the target to be tracked from the multiple candidate target objects based on the image features of the target to be tracked and the deviation.

In some exemplary embodiments, when determining the target to be tracked from the multiple target objects based on the image features of the target to be tracked and the deviation, the processor is used to:
Determine a candidate target object that matches the target to be tracked from the multiple candidate target objects based on the image features of the target to be tracked;
Determine the target to be tracked from the candidate target objects matching the target to be tracked based on the deviation.

In some exemplary embodiments, the processor is used to:
In a process of tracking the target to be tracked, correct the motion information of the target to be tracked is based on the target road area;
Track and photograph the target to be tracked based on corrected motion information.

In some exemplary embodiments, when correcting the motion information of the target to be tracked based on the target road area, the processor is used to:
Obtain target position information of the target to be tracked in the target road area, and replace position information of the target to be tracked with the target location information,
and/or
Replace a motion direction of the target to be tracked with a driving direction corresponding to the target road area.

In some exemplary embodiments, when correcting the motion information of the target to be tracked based on the target road area, the processor is used to:
If a matching degree between the target road area and the target to be tracked is greater than or equal to a preset matching degree, determine a correction coefficient based on the matching degree;
Correct the position information of the target to be tracked based on the correction coefficient and the target position information of the target to be tracked in the target road area,
and/or
Correct the motion direction of the target to be tracked based on the correction coefficient and the driving direction corresponding to the target road area.

In some exemplary embodiments, the processor is used to:
Display the vector map on a display device, the vector map including multiple road areas;
Mark the target to be tracked in real time in the road area on the vector map based on real-time motion information of the target to be tracked.

It should be noted that a person skilled in the art can understand that for the convenience and simplicity of description, the specific working process of the target tracking device described above may be referred to the corresponding process in the aforementioned target tracking method descriptions, which will not be described herein again.

Please refer to FIG. 10, which is a schematic structural block diagram of a movable platform according to some exemplary embodiments of the present disclosure.

As shown in FIG. 10, the movable platform 400 includes a platform body 410, a power system 420, a photographing device 430 and a target tracking device 440. The power system 420 and the photographing device 430 are located on the platform body 410. The power system 420 is used to provide power for the movable platform 400, and the photographing device 430 is used to capture images. The target tracking device 440 is provided in the platform body 410 and is used to control the movable platform 400 to track a target to be tracked. The target tracking device 440 may also be used to control the movement of the movable platform 400, and the target tracking device 440 may be the target tracking device 300 in FIG. 9.

It should be noted that a person skilled in the art may understand that for the convenience and simplicity of description, the specific working process of the movable platform described above may be referred to the corresponding process in the aforementioned target tracking method descriptions, and will not be described herein again.

Some exemplary embodiments of the present disclosure also provide a computer-readable storage medium, the computer-readable storage medium stores a computer program, and the computer program includes program instructions. The processor executes the program instructions to implement the steps of the target tracking method provided herein.

The computer-readable storage medium may be an internal storage unit of the movable platform or a remote control device described in any of the preceding exemplary embodiments, for example, a hard disk or memory of the movable platform or remote control device. The computer-readable storage medium may also be an external storage device of the movable platform or remote control device, for example, the movable platform or remote control device may be equipped with a plug-in hard disk, a smart memory card (SMC), a secure digital (SD) card, a flash memory card (Flash Card), etc.

It should be understood that the terminology used herein is for the purpose of describing particular exemplary embodiments only and is not intended to limit the present disclosure. As used herein, the singular forms “a”, “an” and “the” are intended to include the plural forms unless the context dictates otherwise.

It should also be understood that the term “and/or” as used herein refers to and includes any and all possible combinations of one or more of the associated listed items.

The above are merely some specific exemplary embodiments of the present disclosure, but the scope of protection of the present disclosure is not limited thereto. A person skilled in the art may think of various equivalent modifications or substitutions within the technical scope disclosed herein. These modifications or substitutions should fall within the scope of protection of the present disclosure. Therefore, the scope of protection of the present disclosure is determined by the appended claims.

What is claimed is:

1. A target tracking method, comprising:
obtaining first information including a target to be tracked, and tracking the target to be tracked based on the first information;
in response to a loss of tracking of the target to be tracked, obtaining motion information of the target to be tracked at a moment of the loss of tracking;
matching, based on the motion information, a target area where the target to be tracked is located at the moment of the loss of tracking in a map; and
searching for the target to be tracked that is lost from tracking based on the motion information and the target area.

2. The method according to claim 1, wherein the motion information includes position information and velocity information of the target to be tracked at the moment of the loss of tracking.

3. The method according to claim 2, wherein the obtaining of the motion information of the target to be tracked at the moment of the loss of tracking includes at least one of (A) or (B):
(A) obtaining relative position information of the target to be tracked relative to a movable platform at the moment of the loss of tracking and position information of the movable platform, and
determining the position information of the target to be tracked at the moment of the loss of tracking based on the relative position information and the position information of the movable platform; or
(B) obtaining a plurality frames of the first information, and
determining the velocity information of the target to be tracked at the moment of the loss of tracking based on the plurality frames of the first information.

4. The method according to claim 1, wherein the matching, based on the motion information, of the target area where the target to be tracked is located at the moment of the loss of tracking includes:
obtaining, from the map, a map area corresponding to the position information in the motion information; and
matching, based on the motion information, the target area where the target to be tracked is located at the moment of the loss of tracking in the map area.

5. The method according to claim 4, wherein the obtaining, from the map, the map area corresponding to the position information in the motion information includes:
determining the map area based on a preset area with a position point corresponding to the potion information in the map as a center point.

6. The method according to claim 4, wherein the matching, based on the motion information, of the target area where the target to be tracked is located at the moment of the loss of tracking in the map area includes:
matching, based on the motion information, a target road area where the target to be tracked is located at the moment of the loss of tracking in the map area.

7. The method according to claim 6, wherein the matching, based on the motion information, of the target road area where the target to be tracked is located at the moment of the loss of tracking in the map area includes at least one of (A) or (B):
(A) determining a distance error between the target to be tracked and each road area in the map area based on the position information of the target to be tracked at the moment of the loss of tracking,
determining a matching priority of each road area based on the distance error,
sequentially selecting the road area based on the matching priority, and determining an angle error between a driving direction corresponding to the road area selected and a motion direction of the target to be tracked, and
determining the road area selected as the target road area upon determining that the angle error is less than or equal to a first threshold; or
(B) determining an angle error between a motion direction of the target to be tracked at the moment of the loss of tracking and a corresponding driving direction of each road area in the map area,
determining a matching priority of each road area based on the angle error,
sequentially selecting the road area based on the matching priority,
determining a distance error between the target to be tracked and the road area selected based on the position information of the target to be tracked, and
determining the road area selected as the target road area upon determining that the distance error is less than or equal to a second threshold.

8. The method according to claim 1, further comprising:
obtaining position information of a movable platform; and
obtaining the map based on the position information of the movable platform.

9. The method according to claim 1, wherein the map and the first information meet a condition that at least the map includes a vector map or the first information includes a first image.

10. The method according to claim 1, wherein the searching for the target to be tracked based on the motion information and the target area includes:
adjusting at least one of a collection parameter of a load on a movable platform or a position of the movable platform based on at least a driving direction corresponding to the target area and a motion speed of the target to be tracked at the moment of the loss of tracking;
obtaining second information collected by the load following the adjusting of the at least one of the collection parameter of the load on the movable platform or the position of the movable platform;
identifying at least one target object based on the second information; and
searching for the target to be tracked that is lost from tracking based on the target area, the motion information of the target to be tracked at the moment of the loss of tracking, and motion information of the at least one target object.

11. The method according to claim 10, wherein the adjusting of the collection parameter of the load on the movable platform based on at least the driving direction corresponding to the target area and the motion speed of the target to be tracked at the moment of the loss of tracking includes:
predicting a target motion direction of the target to be tracked based on the driving direction corresponding to the target area and the motion speed of the target to be tracked at the moment of the loss of tracking; and
adjusting the collection parameter of the load on the moveable platform based on the target speed direction predicted.

12. The method according to claim 10, wherein the load includes a photographing device, the second information includes a second image, and the collection parameter includes a photographing direction and a focal length.

13. The method according to claim 10, wherein the adjusting of the position of the position of the movable platform based on at least the driving direction corresponding to the target area and the motion speed of the target to be tracked at the moment of the loss of tracking includes:
determining a moving distance of the movable platform based on the motion speed of the target to be tracked at the moment of the loss of tracking and a during since the moment of the loss of tracking; and
adjusting the position of the movable platform based on the moving distance and the driving direction corresponding to the target area.

14. The method according to claim 10, wherein the searching for the target to be tracked that is lost from tracking based on the target area, the motion information of the target to be tracked at the moment of the loss of tracking, and the motion information of the at least one target object includes:
determining at least one candidate target object located within the target area from a plurality of the target objects based on motion information of the plurality of the target objects;
determining that the least one candidate target object includes a plurality of candidate target objects, and determining a deviation between the motion speed of the target to be tracked at the moment of the loss of tracking and a motion speed of each of the plurality of candidate target objects; and
determining the target to be tracked from the plurality of candidate target objects based on at least the deviation of each of the plurality of candidate target objects.

15. The method according to claim 14, wherein the determining of the at least one candidate target object located within the target area from the plurality of the target objects based on the motion information of the plurality of the target objects includes:
determining a distance between each of the plurality of the target objects and the target area based on position information of the plurality of the target objects; and
determining at least one target object whose distance is less than or equal to a preset distance as the at least one candidate target object located within the target area.

16. The method according to claim 14, wherein the determining of the at least one candidate target object located within the target area from the plurality of the target objects based on the motion information of the plurality of the target objects includes:
matching road areas where the plurality of the target objects are located in the map based on the motion information of the plurality of the target objects; and
determining at least one target object whose road area and the target area are the same as the at least one candidate target object.

17. The method according to claim 14, wherein the determining of the target to be tracked from the plurality of candidate target objects based on the at least the deviation of each of the plurality of candidate target objects includes:
extracting image features of the target to be tracked from the first information; and
determining the target to be tracked from the plurality of candidate target objects based on the image features of the target to be tracked and the deviation.

18. The method according to claim 17, wherein the determining of the target to be tracked from the plurality of candidate target objects based on the image features of the target to be tracked and the deviation includes:
determining at least one matching candidate target object that matches the target to be tracked from the plurality of candidate target objects based on the image features of the target to be tracked; and
determining the target to be tracked from the at least one matching candidate target object based on the deviation of the at least one matching candidate target object.

19. The method according to claim 1, further comprising:
in a process of tracking the target to be tracked, correcting the motion information of the target to be tracked based on the target area; and
tracking and photographing the target to be tracked based on corrected motion information.

20. The method according to claim 1, further comprising:
displaying the map, the map including a plurality of road areas; and
marking the target to be tracked in real time in one of the plurality of road areas of the map based on real-time motion information of the target to be tracked.
